(19) United States
(12) Patent Application Publication
(10) Pub. No.: US 2021/0090149 A1
(43) Pub. Date: Mar. 25, 2021

(54) INTEGRATED ONLINE TRAVEL PLANNING SYSTEM

(71) Applicant: NextPlan, Inc., Palo Alto, CA (US)

(72) Inventor: Mukul Gupta, Palo Alto, CA (US)

(73) Assignee: NextPlan, Inc., Palo Alto, CA (US)

(21) Appl. No.: 16/580,453

(22) Filed: Sep. 24, 2019

(51) Int. Cl. G06Q 30/06; G06Q 50/14

(52) U.S. Cl. CPC G06Q 30/0621; G06Q 30/0623; G06Q 50/14

(57) ABSTRACT

Examples described herein include an online travel planning method, which may include storing a user travel profile that includes one or more user travel characteristics that relate particularly to a user and receiving from the user over a computer network one or more generalized user travel objectives. In some examples the one or more generalized user travel objectives may include an experiential target or a cultural event. The method may further include identifying and providing to the user over the computer network one or more first particularized travel destinations as a generalized customizable travel plan based upon the one or more generalized user travel objectives and at least one of the one or more user travel characteristics of the user travel profile. The first particularized travel destinations may be based upon and include access to particularized arrangements for travel and accommodation.

### BACKGROUND OF THE INVENTION

Online resources to search for and purchase travel services are ubiquitous. Users may access a wide range of online resources, such as websites, for travel ideas and to identify and purchase transportation services, such as airline, train, or bus tickets and/or car rentals and/or lodging accommodations or services such as hotel or motel rooms or temporary cabin, apartment, or house rentals. Typically, a user may separately identify and purchase each leg or portion of one or more transportation services (e.g., airline tickets for each of one or more destinations and any additional transportation services at each destination, such as car rental). Also, the user may separately identify and purchase lodging services at each destination.

For example, online travel logistics sellers may be directed to selling specific transportation segments (e.g., flights and/or car rentals) and/or specific lodging arrangements (e.g., hotel) according to destinations and dates specified by a user. Online travel logistics sellers may be said to focus on how to travel to a destination and may include some focus on costs of travel to the destination, but generally do not focus on or provide significant information about why to go to the destination or what to do at the destination. Examples of online travel logistics sellers may include Expedia.com, Skyscanner.com, Booking.com, etc.

As another example, online inspirational travel planners may be directed to assisting a user to plan a multi-destination trip given dates and in some cases preferences that may be specified by the user. Online inspirational travel planners may be said to focus on providing information about why to go to a destination and/or what to do at the destination, and sometimes on how to travel to the destination, but generally do not focus on or provide significant information about costs to travel to the destination. Examples of online inspirational travel planners may include TripAdvisor.com, Inspirock.com, PickyourTrail.com, Triphobo.com, etc.

As yet another example, online local experience sellers may be directed to selling specific activities to a user at a specified locality, such as tickets or passes for activities or events at the locality for specified dates. Online experience sellers may be said to focus on selling tickets/passes for a given destination and date, but generally do not provide general logistics information about reaching the destination or general inspirational information to distinguish the destination from other prospective destinations. Examples of online local experience may include Utrip.com, Klook.com, Viator.com, or Stubhub.com for activities/tours and Stubhub.com for events such as sports and/or music events.

An aspect of generally distinct online travel logistics sellers, online inspirational travel planners, and online local experience sellers is that a user commonly drawn into a repetitive spiral of separately accessing online travel logistics sellers, online inspirational travel planners, and online local experience sellers to make a travel plan. Online inspirational travel planners may provide general inspiration or ideas for what to do or why to go someplace, but the user must then usually go to online travel logistics sellers to obtain even basic information about travel logistics, particularly costs. After one cycle, a user may return to online inspirational travel planners after learning about higher than expected costs from online travel logistics sellers for alternatives ideas and/or inspirations, and then go back again to online travel logistics to check for costs and logistics associated with the alternatives ideas and/or inspirations. Similar cycles may occur with relation to cost information obtained from online local experience sellers in relation to each selected destination.

A consequence of such a wide range of separate online resources is that users now commonly undergo long, tedious searches through large numbers of travel service options before separately selecting and purchasing each of the travel services of a trip.

### SUMMARY OF THE INVENTION

Examples described herein include an online travel planning method, which may include storing a user travel profile that includes one or more user travel characteristics that relate particularly to a user, and receiving from the user over a computer network one or more generalized user travel objectives. In some examples the one or more generalized user travel objectives may include an experiential target or a cultural event. The method may further include identifying and providing to the user over the computer network one or more particularized travel destinations as a generalized customizable travel plan based upon the one or more generalized user travel objectives and at least one of the one or more user travel characteristics of the user travel profile. The particularized travel destinations may be based upon and include access to particularized arrangements for travel and accommodation.

Other examples may include a computing system that may include one or more processors and memory in communication with the one or more processors to store instructions that may direct the one or more processors to receive from a user one or more generalized user travel objectives, and identify and provide to the user one or more particularized travel destinations as a generalized customizable travel plan based upon the one or more generalized user travel objectives. The first particularized travel destinations may be based upon and include access to particularized arrangements for travel and accommodation.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a block diagram of an example computing system.

FIG. 2 is a schematic illustration of an example of a computing system with an online travel planning system, which may also be referred to as travel agent system, in accordance with embodiments described herein.

FIG. 3 is a flow diagram of an example travel planning process or method in accordance with embodiments described herein.

FIG. 4 is an illustration of a travel planning display interface, as may be rendered on a display screen of a user computer or computing system, in accordance with embodiments described herein.

### DETAILED DESCRIPTION OF PREFERRED EMBODIMENTS

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. The term “module” may refer to software, firmware and/or circuitry that is/are configured to perform or cause the performance of one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may collectively or individually be embodied as circuitry that forms a part of a computing system. As used herein, the term “processor” may be a processor core or multiple processors.

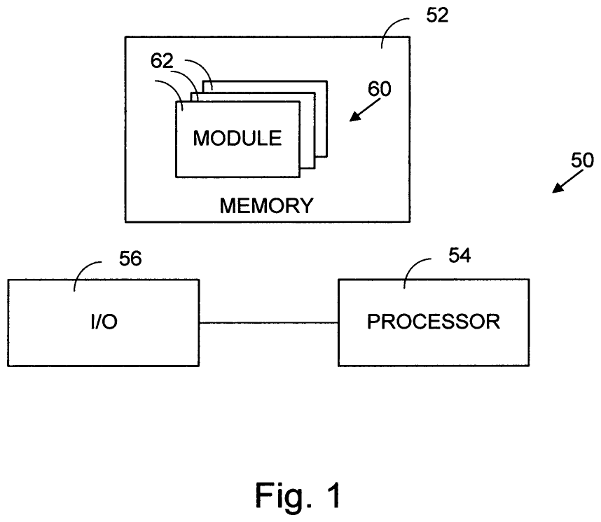

An exemplary embodiment of a computing system 50 is shown in FIG. 1. Computing system 50 includes one or more memory devices 52 (one shown) in communication with one or more programmable processors 54 (one shown). Memory 52 and processor 54 may be in communication with one or more input/output devices or ports, shown collectively as I/O 56.

Memory 52 may include both instructions that are executable by processor 54 and related data. Memory 52 may be implemented on a computer readable medium, as would be understood to a person of ordinary skill in the art. Such a medium may be, for example and without limitation, a non-volatile memory device, a hard drive, a compact disk that may be read by a compact disk drive, an integrated circuit, or other machine-readable memory device.

In the illustrated embodiment, executable instructions in memory 52 are shown as computer program logic 60 that may be implemented as one or more modules 62 and may cause processor 54 to perform one or more functions in response thereto. Accordingly, modules 62 may refer to computer program logic 60 in memory 52 and/or operation of processor 54 executing computer program logic 56.

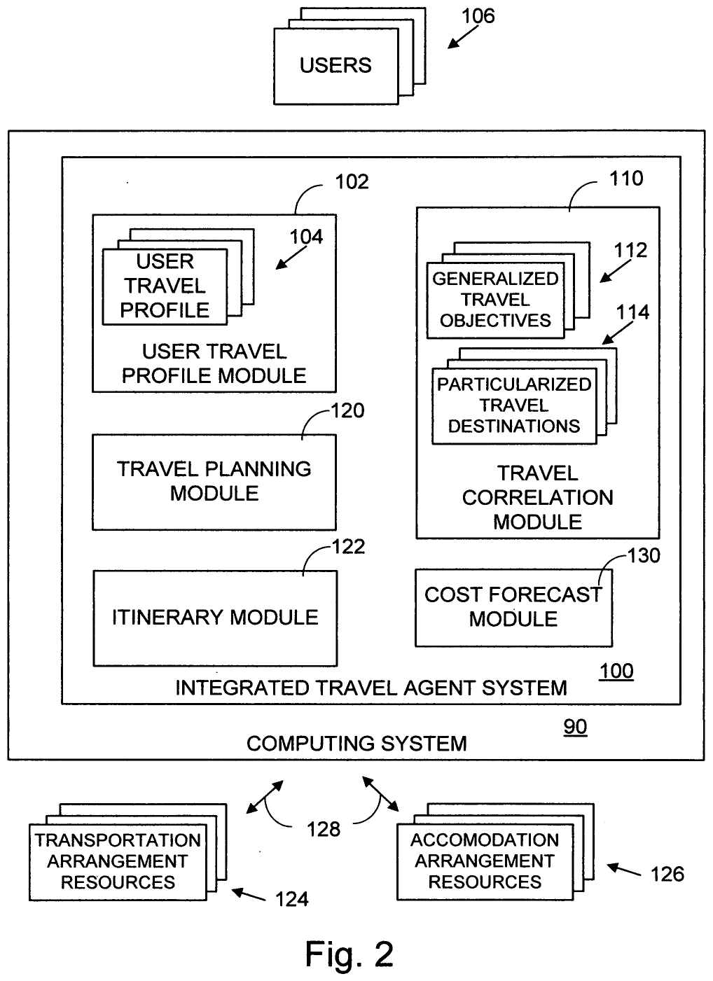

FIG. 2 is a schematic illustration of at least one computing system 90, which may be analogous to and/or include elements of computing system 50 and may operate software and/or software instructions to provide an integrated online travel planning system, which may also be referred to as integrated travel agent system 100.

Integrated travel agent system 100 may include a user travel profile module 102 that may store and/or have access to one or more user travel profiles 104 for each of one or more users 106. The user travel profiles 104 may include one or more user travel characteristics that may relate particularly to the respective users and may include one or more of a user identifier (ID), preferred travel grade (e.g., economy, first class, etc.), preferred accommodation grade (e.g., economy, luxury, 3-star, etc.), preferred accommodation style (e.g., hotel, motel, resort, apartment, cabin, etc.), preferred/rejected travel season and/or dates, preferred/rejected travel areas (e.g., regional, national, and/or international), and/or one or more travel companions (e.g., immediate family members, extended family members, friends, etc.).

Integrated travel agent system 100 may also include a travel correlation module 110 that may correlate each of plural generalized user travel objectives 112 with one or more particularized travel destinations 114. Each particularized travel destination 114 may refer to a particular location, such as a city, town, or other locale.

Each generalized user travel objective 112 may include one or more of a generalized travel destination, an experiential target, or a cultural event, for example. As examples, a generalized travel destination may include a city, a geographic region or location, a geo-political area (e.g., a state or cultural region, or a portion of one). An experiential target may include one or more natural or cultural features that may be located at or characteristic of a place, such as “cherry blossoms” may be a natural feature characteristic of Washington D.C. or Kyoto, Japan, “geysers” may be a natural feature characteristic of Yellowstone National Park or Iceland, “terracotta army” may be a cultural feature characteristic of a collection of terracotta sculptures depicting soldiers at Emperor Qinshihuang's Mausoleum Site Museum in Lintong, Xi'an, Shaanxi, China, and “pyramid” may be a cultural feature characteristic of a collection of structures that may be located near Giza, Egypt or Tulum, Mexico, as examples. A cultural event may include any of a wide range of events that may include performing arts (e.g., “Metropolitan Opera,” which may refer to one or more opera performances by the Metropolitan Opera of New York), sporting events (e.g., “World Cup” may refer to one or more matches relating to the men's or women's World Cup championship in soccer, “Super Bowl” may refer to the championship game of the National Football League, “British Open” may refer to a golf tournament or a tennis tournament of that name), or other cultural events (e.g., “Hajj” may refer to an annual Islamic pilgrimage to Mecca, Saudi Arabia, “Carnival” may refer to a pre-Lent festival in a place such as Rio de Janeiro, Brazil or New Orleans, La. USA, and “Burning Man” may refer to an annual event in the western United States in the Black Rock Desert of northwest Nevada, USA).

Integrated travel agent system 100 may also include a travel planning module 120 to receive a selected generalized user travel objective 112 from a selected user 106 in connection with user interaction with integrated travel agent system 100. The selected user 106 may communicate with integrated travel agent or integrated travel planning system 100 with a user computer (not shown) over a computer network such as the Internet.

Travel planning module 120 may provide to the travel correlation module 110 the selected generalized user travel objective 112 received from selected user 106. In response, the travel correlation module 110 may provide one or more particularized travel destinations 114 that may correspond with the selected generalized user travel objective 112 received from the selected user 106. The one or more particularized travel destinations 114 may be displayed for or otherwise provided to the selected user 106 and/or stored in association with the user travel profile 104 of the selected user 106. A particularized travel destination 114 may include one or more specific locations (e.g., towns, cities, and/or regions). Travel correlation module 110 and travel planning module 120 may operate generally as an online inspirational travel planner that operates within integrated travel agent system 100 in reference to the selected generalized user travel objective 112 and the user travel preference profile 104.

Integrated travel agent system 100 may also include or be in communication with an itinerary module 122 that may include access to one or more transportation arrangement resources 124 and/or one or more lodging or accommodation arrangement resources 126. In the example of FIG. 2, the one or more transportation arrangement resources 124 and the one or more lodging or accommodation arrangement resources 126 may be distinct and remote from the computing system 90 and may communicate with it via a computer network 128, which may include the Internet in some examples. In other examples, the one or more transportation arrangement resources 124 and the one or more lodging or accommodation arrangement resources 126 may be included in integrated travel agent system 100.

Based on the particularized travel destinations and one or more corresponding user travel characteristics from the user travel profile 104 of the selected user 106, itinerary module 122 may communicate with the one or more transportation arrangement resources 124 to obtain information regarding transportation (e.g., scheduled airline flights, train schedules, car rentals, and associated costs) to the one or more particularized travel destinations 114, and may communicate with the one or more lodging or accommodation arrangement resources 126 to obtain information regarding lodging or accommodations at the one or more particularized travel destinations 114 (e.g., particular lodging options, including costs, lodging facilities and amenities). The travel planning module 120 may receive from itinerary module 122 the information that itinerary module 122 receives regarding transportation to the one or more particularized travel destinations 114 and the information regarding lodging or accommodations at the one or more particularized travel destinations 114. Itinerary module 122 may operate generally as an online logistics seller or planner that operates within integrated travel agent system 100 in reference to the particularized travel destinations and the user travel preference profile 104.

The travel planning module 120 may provide to and display for the selected user 106, and/or store in association with the user travel profile 104 of the selected user 106, the information regarding transportation to the one or more particularized travel destinations 114 and the information regarding lodging or accommodations at the one or more particularized travel destinations 114, including costs of the associated transportation and lodging or accommodations. As a result, integrated travel agent system 100 may provide user 106 with particularized travel information, including costs, based upon selected generalized user travel objective 112 from user 106. As a result, integrated travel agent system 100 may spare a user from a conventional repetitive spiral of separately accessing separate online travel logistics sellers, online inspirational travel planners, and online local experience sellers to make a travel plan.

In addition, travel planning module 120 may provide to and display for the selected user 106, and/or store in association with the user travel profile 104 of the selected user 106, information regarding transportation to one or more additional particularized travel destinations and the information regarding lodging or accommodations and/or information about one or more local activities, including costs, at the one or more additional particularized travel destinations. The user may select one or more of the one or more first particularized travel destinations and/or the one or more additional particularized travel destinations, thereby to establish a trip plan, and may receive an incremental cost for each of the selected particularized travel destination and a cumulative total of costs for the selected destinations and activities. In some examples, the user may select a sequence of the particularized travel destinations.

In some examples, itinerary module 122 may obtain information regarding transportation to one or more additional particularized travel destinations and the information regarding lodging or accommodations and/or information about one or more local activities, including costs, at the one or more additional particularized travel destinations by communicating with the As an alternative to one or more transportation arrangement resources 124 to obtain information regarding transportation (e.g., scheduled airline flights, train schedules, car rentals, and associated costs) to the one or more particularized additional travel destinations, and may communicate with the one or more lodging or accommodation arrangement resources 126 to obtain information regarding lodging or accommodations at the one or more additional particularized travel destinations (e.g., particular lodging options, including costs, lodging facilities and amenities).

In other examples, integrated travel agent system 100 may also include a cost forecast module 130 from which itinerary module 122 may obtain information regarding transportation to one or more additional particularized travel destinations and the information regarding lodging or accommodations and/or information about one or more local activities, including costs, at the one or more additional particularized travel destinations. Cost forecast module 130 may operate as an alternative to one or more transportation arrangement resources 124 and one or more lodging or accommodation arrangement resources 126 to provide itinerary module 122 estimated information regarding transportation to one or more additional particularized travel destinations and the information regarding lodging or accommodations and/or information about one or more local activities, including costs, at the one or more additional particularized travel destinations. Cost forecast module 130 may allow integrated travel agent system 100 to forego excessive accessing of the one or more transportation arrangement resources 124 and the one or more lodging or accommodation arrangement resources 126 to reduce costs and delays that may be associated with access such resources.

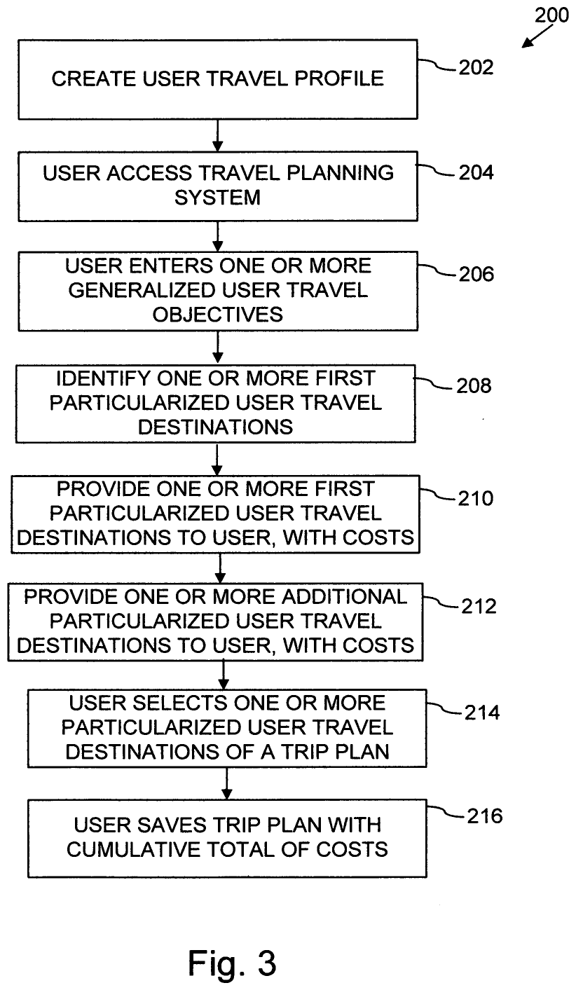

FIG. 3 is a flow diagram of an example travel planning process or method 200 that may be implemented on various computing systems described herein, such as computing system 90 operating integrated travel agent system 100, in accordance with various embodiments. In various embodiments, process 200 may be performed with more or fewer modules and/or with some operations in different order.

The process 200 may include an operation 202 in which a user travel profile may be created for or by a user with one or more user travel characteristics that may relate to the user and may include one or more of a user identifier (ID), preferred travel grade, preferred accommodation grade, preferred accommodation style, preferred/rejected travel season and/or date, preferred/rejected travel areas (e.g., regional, national, international), and/or one or more travel companions (e.g., immediate family members, extended family members, friends, etc.). In some examples, the user travel profile may be entered by the user in one or more sessions or may include information retrieved in relation to the user from one or more other network-connected resources.

The process 200 may include an operation 204 in which a user may access an online travel planning system, such as integrated travel agent system 100, for example. In embodiments, a user may access such a travel planning system over a computer network, such as the Internet, by entering or otherwise using an account name and/or a password. In some examples, the account name and/or password may have been set during prior access to the travel planning system or may be set as part of operation 202.

The process 200 may include an operation 206 in which the integrated online travel planning system may receive from the user one or more generalized user travel objectives, wherein each generalized user travel objective may correspond to or include one or more of a generalized travel destination, an experiential target, or a cultural event, which may be analogous to a generalized user travel objective 112 described above.

The process 200 may include an operation 208 in which one or more first particularized travel destinations may be identified based upon the one or more generalized user travel objectives. In some examples, the one or more first particularized travel destinations may be identified also as correlating with or being compatible with one or more user travel characteristics of the user travel profile and may include cost information, such as cost summaries, for transportation and lodging or accommodations.

The process 200 may include an operation 210 in which the one or more first particularized travel destinations, including cost information for transportation and lodging or accommodations, may be provided (e.g., displayed) to the user and/or stored in connection with the user travel profile.

The process 200 may include an operation 212 in which one or more additional particularized travel destinations may be provided (e.g., displayed) to the user and/or stored in connection with the user travel profile, as one or more alternatives to the one or more first particularized travel destinations and/or as one or more additional particularized travel destinations that may be combined with the one or more first particularized travel destinations.

The process 200 may include an operation 214 in which the user selects one or more of the one or more first particularized travel destinations and/or the one or more additional particularized travel destinations, thereby to establish a trip plan. In some examples, the user may select a sequence of the particularized travel destinations. Upon user selection user of one or more of the one or more first particularized travel destinations and/or the one or more additional particularized travel destinations, the user may receive an incremental cost for each of the selected particularized travel destinations and a cumulative total of costs for the selected destinations and activities.

The process 200 may include an operation 216 in which the user saves the trip plan in association with the user travel profile, wherein the trip plan may include a cumulative total of costs for the selected destinations and activities. In some examples, the user may save the trip plan as a current trip plan or as one of one or more future (e.g., dream) trip plans.

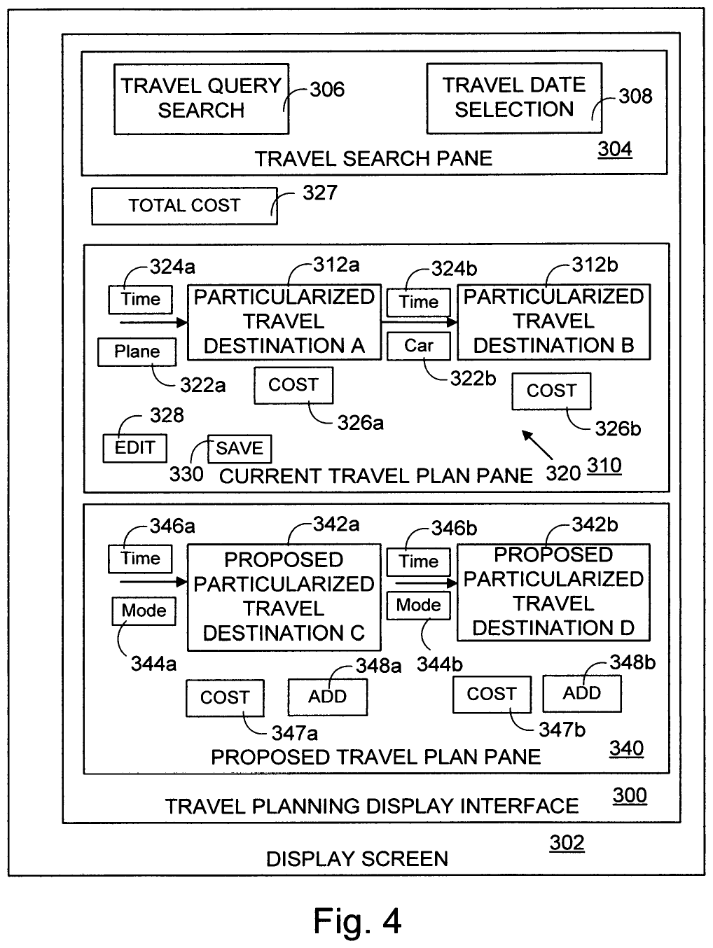

FIG. 4 is an illustration of a travel planning display interface 300, as may be rendered on a display screen 302 of a user computer or computing system in communication with a travel planner and/or a travel agent system as described herein, such as integrated travel agent system 100, for example. In some examples, travel planning display interface 300 may be rendered in connection with operation of travel planning process 200.

Travel planning display interface 300 may include a travel search pane 304 that may include a travel query search block 306 to receive from a user a travel query, which may be or include a generalized user travel objective (e.g., user travel objective 112) and/or a particularized travel destination (e.g., travel destination 114). Travel search pane 304 may also include a travel date selection block 308, which in some examples may include a drop-down menu that may list by name one or more pre-defined future travel periods. For a user located in the United States, for example, the one or more pre-defined future travel periods may include any of various holiday periods such as Thanksgiving break, winter holiday break (e.g., Christmas to New Year's Day), Martin Luther King holiday, etc. Alternatively, the one or more pre-defined future travel periods may include any travel periods relevant to the location (e.g., country) where the user is located or resides. In addition or alternatively, travel date selection block 308 may link to or otherwise access a calendar for the user to select specific travel days. In some examples, the one or more pre-defined future travel periods may correspond to travel periods that may be associated with the user-specific characteristics in user profile 104, such as one or more pre-selected travel dates of the user and/or one or more predefined potential travel periods associated with the user such as academic breaks or vacations for a child or children of the user or closure periods for an employer of the user, for example.

Travel planning display interface 300 may include a current travel plan pane 310 in which to display one or more particularized travel destinations 312 (two shown as 312a and 312b, as an example), which together may form a current trip plan 320. In some examples, trip plan 320 with plural particularized travel destinations 312 (e.g., particularized travel destinations 312a and 312b) may include a travel mode indicator 322 that may indicate by text or graphic icon a planned mode of travel to one or more of particularized travel destinations 312a and 312b (e.g., automobile, airplane, train, bus, or ship/boat).

In the example of FIG. 4, trip plan 320 may include a travel mode indicator 322a indicating an airplane mode of travel to particularized travel destination 312a (e.g., as a long-distance and/or international leg of travel plan 320) and a travel mode indicator 322b indicating an automobile mode of travel to particularized travel destination 312b (e.g., as a localized leg of travel plan 320 from particularized travel destination 312a to particularized travel destination 312b). In some examples, trip plan 320 may include for one or more of travel mode indicators 322 corresponding travel time indications 324 (e.g., travel time indications 324a and 324b) that may indicate an estimated travel time via the corresponding travel mode.

Each particularized travel destination 312 may have associated with it one or more of a travel mode and route to reach the particularized travel destination 312 and an accommodation at the particularized travel destination 312, wherein the travel mode and route and/or the accommodation may be selected by the travel planning system and/or travel agent system based upon one or more characteristics of the user included in the user travel profile. In some examples, the user may view or receive information regarding travel to and accommodation at the particularized travel destination 312 by selecting or activating the display indicating the particularized travel destination 312. Such information may include one or more of cost, particular accommodation or travel arrangements, etc. In some examples, each particularized travel destination 312 (e.g., particularized travel destinations 312a and 312b) may include a display of its associated cost 326 (e.g., costs 326a and 326b) that may indicate cost for travel and accommodations, and current travel plan pane 310 may include a total cost indicator 327 that may indicate a total cost for travel and accommodations associated with the one or more particularized travel destinations 312 of trip plan 320.

Current travel plan pane 310 may include one or more trip plan edit controls 328 (one shown in this example) that the user may activate to edit trip plan 320. User editing of trip plan 320 may include any of modifying any travel or accommodation associated with any particularized travel destination 312, removing, adding, or changing any sequence of any particularized travel destination 312. Current travel plan pane 310 also may include a trip plan save control 330 by which a user may save trip plan 320 in association with the user travel profile of the user. In some examples, the trip plan save control 330 may allow the trip plan to be saved as a current trip plan or, alternatively, as one of one or more potential future trip plans.

In some examples, travel planning display interface 300 may also include a proposed travel plan pane 340 in which to display one or more proposed particularized travel destinations 342 (e.g., two shown as 342a and 342b) as proposed additional and/or substitute particularized travel destinations 342 that the user may select to be incorporated into the current trip plan 320 displayed in current travel plan window pane 310, either in addition to or as substitutes for one or more of particularized travel destinations 312 of current trip plan 320. In some examples, proposed travel plan pane 340 may include for proposed particularized travel destinations 342 (e.g., 342a and 342b) a travel mode indicator 344 that may indicate a planned mode of travel to one or more of proposed particularized travel destinations 342a and 342b (e.g., automobile, airplane, train, bus, or ship/boat). Travel mode indicators 344 may be analogous to travel mode indicators 322. In some examples, proposed travel plan pane 340 may include for one or more of travel mode indicators 344 travel time indications 346 (e.g., travel time indications 346a and 346b) that may indicate an estimated travel time via the corresponding travel mode. Proposed travel plan pane 340 may include may include a display of its associated cost 347 (e.g., costs 347a and 347b) that may indicate cost for travel and accommodations for each particularized travel destination 342 (e.g., particularized travel destinations 342a and 342b), and one or more add controls 348 (e.g., two shown as 348a and 348b) by which the user may add the corresponding proposed particularized travel destination 342a and/or 342b to trip plan 320. In some examples proposed travel plan pane 340 may refer to the one or more proposed particularized travel destinations 342 as being proximal to or being frequently visited with one or more of the particularized travel destinations 312 of current trip plan 320, or as being with a user's wishlist of destinations or as having been recently viewed by the user. Upon either or both of particularized travel destinations 342a and/or 342b being added to trip plan 320, the corresponding cost 347 (e.g., costs 347a and/or 347b) may be added to and indicated in total cost display 327.

Having described and illustrated the principles of the invention in a preferred embodiment thereof, it should be apparent that the invention may be modified in arrangement and detail without departing from such principles. I claim all modifications and variations coming within the spirit and scope of the following claims.

1. A computing system comprising one or more processors and memory in communication with the one or more processors to store instructions that direct the one or more processors to receive from a user one or more generalized user travel objectives, identify and provide to the user one or more first particularized travel destinations as a generalized customizable travel plan based upon the one or more generalized user travel objectives, wherein the first particularized travel destinations are based upon and include access to particularized arrangements for travel and accommodation.

2. The computing system of claim 1 wherein the access to the particularized arrangements for travel and accommodation includes a display of total costs for the particularized arrangements for travel and accommodation.

3. The computing system of claim 2 wherein the one or more generalized user travel objectives include an experiential target or a cultural event.

4. The computing system of claim 2 wherein the instructions include instructions to direct the one or more processors to receive the one or more generalized user travel objectives from the user over a computer network and instructions to provide the one or more first particularized travel destinations to the user over the computer network.

5. The computing system of claim 2 wherein the instructions include instructions to direct the one or more processors to receive a user travel profile that includes one or more user travel characteristics that relate particularly to the user and to identify and provide to the user the one or more first particularized travel destinations as the generalized customizable travel plan based upon the one or more generalized user travel objectives and at least one of the one or more user travel characteristics of the user travel profile.

6. The computing system of claim 5 wherein the instructions include instructions to direct the one or more processors to provide to the user one or more second particularized travel destinations based upon the one or more generalized user travel objectives and at least one of the one or more user travel characteristics of the user travel profile and to allow the user to incorporate at least one of the one or more second particularized travel destinations into the generalized customizable travel plan.

7. The computing system of claim 5 wherein the instructions include instructions to direct the one or more processors to allow the user to incorporate at least one of the one or more second particularized travel destinations into the generalized customizable travel plan selectively in addition to or in substitution for any of the one or more first particularized travel destinations.

8. The computing system of claim 5 wherein the one or more user travel characteristics of the user travel profile may relate to one or more of a travel grade, an accommodation grade preferred by the user, a user travel time preference, a user travel area preference, and one or more travel companions of the user.

9. The computing system of claim 3 wherein the instructions include instructions to direct the one or more processors to receive a user travel profile that includes one or more user travel characteristics that may relate particularly to the user and to identify and provide to the user the one or more first particularized travel destinations as the generalized customizable travel plan based upon the one or more generalized user travel objectives and at least one of the one or more user travel characteristics of the user travel profile.

10. The computing system of claim 3 wherein the instructions include instructions to direct the one or more processors to receive the particularized arrangements for travel and accommodation of the first particularized travel destinations over a computer network from one or more remote computer systems.

11. An online travel planning method, comprising: storing a user travel profile that includes one or more user travel characteristics that relate particularly to a user, receiving from the user over a computer network one or more generalized user travel objectives, identifying and providing to the user over the computer network one or more first particularized travel destinations as a generalized customizable travel plan based upon the one or more generalized user travel objectives and at least one of the one or more user travel characteristics of the user travel profile, wherein the first particularized travel destinations are based upon and include access to particularized arrangements for travel and accommodation, including a display of total costs for the particularized arrangements for travel and accommodation.

12. The method of claim 11 wherein the one or more generalized user travel objectives include an experiential target or a cultural event.

13. The method of claim 11 further comprising providing to the user over the computer network one or more second particularized travel destinations based upon the one or more generalized user travel objectives and the at least one of the one or more user travel characteristics of the user travel profile and allowing the user to incorporate at least one of the one or more second particularized travel destinations into the generalized customizable travel plan.

14. The method of claim 13 further comprising allowing the user to incorporate the at least one of the one or more second particularized travel destinations into the generalized customizable travel plan selectively in addition to or in substitution for any of the one or more first particularized travel destinations and including in the display of total costs costs associated the at least one of the one or more second particularized travel destinations incorporate into the generalized customizable travel plan.

15. The method of claim 11 wherein the one or more user travel characteristics of the user travel profile may relate to one or more of a travel grade, an accommodation grade preferred by the user, a user travel time preference, a user travel area preference, and one or more travel companions of the user.

16. The method of claim 11 further comprising receiving the particularized arrangements for travel and accommodation of the first particularized travel destinations over the computer network from one or more remote computer systems.

17. An online travel planning method, comprising: storing a user travel profile that includes one or more user travel characteristics that relate particularly to a user, receiving from the user over a computer network one or more generalized user travel objectives, displaying to the user over the computer network one or more first particularized travel destinations as a generalized customizable travel plan based upon the one or more generalized user travel objectives and at least one of the one or more user travel characteristics of the user travel profile, and displaying costs for travel to and accommodation at the one or more first particularized travel destinations, wherein the first particularized travel destinations are based upon and include access to particularized arrangements for travel and accommodation.

18. The method of claim 17 wherein the one or more generalized user travel objectives include an experiential target or a cultural event.

19. The method of claim 17 further comprising displaying to the user over the computer network one or more second particularized travel destinations based upon the one or more generalized user travel objectives and the at least one of the one or more user travel characteristics of the user travel profile and allowing the user to incorporate at least one of the one or more second particularized travel destinations into the generalized customizable travel plan.

20. The method of claim 19 further comprising allowing the user to incorporate the at least one of the one or more second particularized travel destinations into the generalized customizable travel plan selectively in addition to or in substitution for any of the one or more first particularized travel destinations.
